(19) United States
(12) Patent Application Publication
(10) Pub. No.: US 2005/0188016 A1
(43) Pub. Date: Aug. 25, 2005

(54) Method and system for off-line, on-line, and instant-message-based multimedia collaboration

(76) Inventors: Subramanyam Vdaygiri, Plainsboro, NJ (US); Arturo Pizano, Belle Mead, NJ (US); Chellury R. Sastry, South Brunswick, NJ (US)

Correspondence Address: Siemens Corporation;Intellectual Property Department, 170 Wood Avenue South, Iselin, NJ, 08830, US

(21) Appl. No.: 10/721,957

(22) Filed: Nov. 25, 2003

Related U.S. Application Data
(60) Provisional application No. 60/428,815, filed on Nov. 25, 2002.

(51) Int. Cl. G06F 15/16

(52) U.S. Cl. 709/205

(57) ABSTRACT

A method for multimedia collaboration between a plurality of users including a host of a collaboration event includes storing an interface representative of the plurality of users in a memory location commonly accessible to the users; creating a composite document from selected source materials; selectively annotating the composite document; and personalizing the composite document with browser based annotations to form a collaboration document. A step of selecting a collaboration mode includes selecting a plurality of offline, near real time, real time, and disconnected modes and causing a selective seamless transition from one selected mode to another.

### CROSS-REFERENCE TO RELATED APPLICATIONS

Specific reference is hereby made to Provisional Patent Application No. 60/428,815 (Atty Dkt No. 2002P19339US) filed Nov. 25, 2002, and entitled AN INTEGRATED SYSTEM FOR OFF-LINE, ON-LINE AND INSTANT-MESSAGE-BASED MULTIMEDIA COLLABORATION, whereof the benefit of priority is claimed and whereof the disclosure is herein incorporated by reference.

The present invention relates to multimedia collaboration and, more specifically, to instant-message-based multimedia collaboration as implemented with the use of digital programmable computers.

### STATEMENT REGARDING FEDERALLY SPONSORED RESEARCH OR DEVELOPMENT

This invention was not made by an agency of the U.S. Government or under a contract with any agency of the U.S. Government.

### BACKGROUND OF THE INVENTION

Generally, there are currently three basic modes in which people use computer-based tools to work with each other in situations where they are separated by time and space boundaries. These are:
Offline: wherein participants rely primarily on e-mail with document attachments;
Near Real Time: wherein participants relay on best-effort peer-to-peer communication tools, most noticeably Instant messaging, together with some other form of information exchange, e.g. peer-to-peer file sharing; and
Real time: wherein participants rely on an on-line voice communication channel and tools like whiteboards, application sharing (such as Net Meeting and WebEx) tools to exchange information.

### BRIEF SUMMARY OF THE INVENTION

It is herein recognized that the above typical collaboration solutions have respective advantages and disadvantages that make them suitable for use in particular situations. A primary disadvantage of state-of-the-art methods is that nearly all collaboration sessions today are conducted in an ad-hoc manner. The above solutions do not address the need for effective ways to combine information from disparate sources as may be typically required for a collaboration session. Solutions such as NetMeeting, for example, require high bandwidth and special infrastructure, while solutions like WebEx, for example, are not only costly and proprietary but also do not allow harnessing and integration of knowledge gathered during collaboration sessions.

It is herein recognized that, in view of these disadvantages, there is a need for a comprehensive collaboration solution that can essentially address all of the three modes listed above. It is an object of the present invention to address such needs so that users are thereby enabled to make the appropriate choices depending on the situation they face at a particular time.

A method for multimedia collaboration between a plurality of users including a host of a collaboration event includes storing an interface representative of the plurality of users in a memory location commonly accessible to the users; creating a composite document from selected source materials; selectively annotating the composite document; and personalizing the composite document with browser based annotations to form a collaboration document. A step of selecting a collaboration mode includes selecting a plurality of offline, near real time, real time, and disconnected modes and causing a selective seamless transition from one selected mode to another.

In accordance with another aspect of the invention, a method for multimedia collaboration between a plurality of users includes a host of a collaboration event, comprising the steps of: storing an interface representative of the plurality of users in a memory location commonly accessible to the users; creating a composite document from selected source materials; selectively annotating the composite document; and personalizing the composite document with browser based annotations to form a collaboration document.

In accordance with another aspect of the invention, a method for multimedia collaboration between a plurality of users of a collaboration event, comprises the steps of: storing an interface representative of the plurality of users in a memory location commonly accessible to the users; creating a composite document from selected source materials; selectively annotating the composite document; personalizing the composite document with browser based annotations to form a collaboration document; storing the collaboration document in the memory location commonly accessible to the users; establishing instant conferencing amongst the plurality of users; selectively making and locally storing further annotations to the collaboration document; selectively sending at a desired time the further annotations to the collaboration document in the memory location commonly accessible to the users; and wherein the foregoing steps are also selectively performed in an ongoing manner during the instant conferencing.

In accordance with another aspect of the invention, a method for multimedia collaboration between a plurality of users includes a host of a collaboration event, comprising the steps of: storing an interface representative of the plurality of users in a memory location commonly accessible to the users; creating a composite document from selected source materials; selectively annotating the composite document; personalizing the composite document with browser based annotations to form a collaboration document; storing the collaboration document in the memory location commonly accessible to the users; sharing retrieval address information for the collaboration document with the users; making and locally storing further annotations to the collaboration document; and selectively sending at a desired time the further annotations to the collaboration document in the memory location commonly accessible to the users.

In accordance with another aspect of the invention, a method for multimedia collaboration between a first user and at least a second user, comprises the steps of: the first user selecting a document page for the collaboration; the first user optionally associating user-entered data with the document page; the first user saving the document page together with the user-entered data associated therewith as a collaboration document in a memory location commonly accessible to the first and the second user; the first and second users establishing message communication for the collaboration; the second user retrieving the collaboration document, including the user-entered data associated therewith; and the first and second users optionally modifying the user-entered data in the context of the collaboration.

In accordance with another aspect of the invention, a system for multimedia collaboration between a plurality of users including a host of a collaboration event, comprises: apparatus for storing an interface representative of the plurality of users in a memory location commonly accessible to the users; apparatus for creating a composite document from selected source materials; apparatus for selectively annotating the composite document; and apparatus for personalizing the composite document with browser based annotations to form a collaboration document.

In accordance with another aspect of the invention, a system for multimedia collaboration between a plurality of users of a collaboration event, comprises: apparatus for storing an interface representative of the plurality of users in a memory location commonly accessible to the users; apparatus for creating a composite document from selected source materials; apparatus for selectively annotating the composite document; apparatus for personalizing the composite document with browser based annotations to form a collaboration document; storing the collaboration document in the memory location commonly accessible to the users; establishing instant conferencing amongst the plurality of users; selectively making and locally storing further annotations to the collaboration document; selectively sending at a desired time the further annotations to the collaboration document in the memory location commonly accessible to the users; and wherein the foregoing steps are also selectively performed in an ongoing manner during the instant conferencing.

In accordance with another aspect of the invention, a system for multimedia collaboration between a plurality of users including a host of a collaboration event, comprises: apparatus for storing an interface representative of the plurality of users in a memory location commonly accessible to the users; apparatus for creating a composite document from selected source materials; apparatus for selectively annotating the composite document; apparatus for personalizing the composite document with browser based annotations to form a collaboration document; apparatus for storing the collaboration document in the memory location commonly accessible to the users; apparatus for sending retrieval address information for the collaboration document to the users; apparatus for making and locally storing further annotations to the collaboration document; and apparatus for selectively sending at a desired time the further annotations to the collaboration document in the memory location commonly accessible to the users.

In accordance with another aspect of the invention, a method for multimedia collaboration between a plurality of users for a collaboration event, comprises the steps of: storing an interface representative of the plurality of users in a memory location commonly accessible to the users; creating a composite document from selected source materials; selectively annotating the composite document; personalizing the composite document with browser based annotations to form a collaboration document; storing the collaboration document in the memory location commonly accessible to the users; sharing retrieval address information for the collaboration document with the users; selecting a collaboration mode for the collaboration event respecting the collaboration document, wherein the collaboration mode comprises any of the offline, near real time, real time, and disconnected modes.

It is an object of the present invention to provide for a collaboration workflow that is simple to use and that has consistent interfaces such that users can easily and readily use the collaboration tools for everyday interactions.

It is a further object of the present invention to provide a collaboration solution that is effective in that it helps users in personalizing the information they commonly use in the execution of a task. Typically this information is present in office documents, Internet and intranet sites, rich multimedia, including audio and video, for collaboration sessions.

It is a further object of the present invention to enable users to set up and schedule collaboration sessions with other users without having to go through complex procedures. The collaboration software in accordance with the invention is able to take into consideration issues such as network bandwidth and limitations in the device capabilities of various participants in a collaboration session.

It is a further object of the present invention to provide a cost effective solution so that users do not have to worry or be concerned about costs in order to interact with each other for sharing information and knowledge.

It is still a further object of the present invention to meet a critical need for an enterprise to streamline all collaboration events, whether it is offline, near on-line or real time, as part of its business processes in order to become a knowledge enterprise.

### BRIEF DESCRIPTION OF THE SEVERAL VIEWS OF THE DRAWINGS

The invention will be more fully understood from the detailed description of the preferred embodiments which follows, in conjunction with the various figures of the drawings, in which

FIG. 1 shows the creation of a composite document by a host in accordance with the principles of the present invention;

FIG. 2 shows highlighting of specific regions of a document and adding synchronous voice annotation, in accordance with the principles of the present invention;

FIG. 3 shows the sending of a URL link to an annotated composite document, in accordance with the principles of the present invention;

FIG. 4 shows the creation and selection of a virtual video clip in accordance with the principles of the present invention;

FIG. 5 shows a near real time collaboration scenario, in accordance with the principles of the present invention; and

FIG. 6 shows a history of annotations, in accordance with the principles of the present invention.

### DETAILED DESCRIPTION OF THE INVENTION

An exemplary embodiment of the present invention to be described provides a collaboration solution that can work effectively with e-mail clients, instant messaging clients and web browser. This is particularly desirable because users are most familiar with these tools and environments. As the driving force behind all collaborative solutions is the need to share information, a principle of the present invention is to help users collaborate not only using office documents like MSWord, Excel, PDF, PowerPoint, Raster and Vector graphics but also with web-based content, e.g. HTML. An embodiment of the invention comprises components that automatically process the documents needed for a collaborative session and convert them into web-based documents (bandwidth/device adaptive graphics or html documents).

As specific parts only of different documents might be needed for a particular collaborative session, the invention allows the participants to combine specific elements from several documents with different formats into one seamless web-based composite document. The system in accordance with the present invention currently interacts with documents stored in document repositories that can range from simple file systems to complete content management systems like SharePoint and InterWoven.

A characteristic of the system in accordance with the invention is provided by the use of the dynamic annotation concept, as described in U.S. Pat. No. 5,838,313, entitled MULTIMEDIA-BASED REPORTING SYSTEM WITH RECORDING AND PLAYBACK OF DYNAMIC ANNOTATION, and issued in the names of Hou et al. on Nov. 17, 1998, and whereof the disclosure is herein incorporated by reference to the extent not incompatible with the present invention, so that participants are enabled to combine voice commentary with synchronized drawings and markings that can be used to highlight particular aspects of the document. Thus, users can easily and quickly highlight important parts, add personal comments and contextual information that was not present in the original documents. The composite document, along with voice and graphic annotations from different participants, can be saved for future reference as a collaboration document. The collaboration components herein described can be customized to the various needs and workflows used by participants, and can also be integrated with the application sharing and whiteboard capabilities of existing systems.

Currently for offline (asynchronous) collaboration, most users collaborate by exchanging e-mail messages. Although this allows participants to participate at their own pace, users typically have to spend a lot of time in typing large amounts of text to discuss a particular topic. The problem becomes more severe when users are collaborating using document attachments. This mode generally leads to large documents being exchanged as attachments back and forth between users and it can typically also cause inconsistencies to arise as several versions of the documents need to be tracked.

The present invention allows users to quickly and easily select parts of document(s), add personal comments through voice/graphic annotations, save the document as a personalized collaboration document, and send its URL to recipients for viewing. This is a very important feature because it allows a centralized version of the documents to be maintained.

For example, a user can choose specific pages from document(s) stored in the SharePoint portal and automatically have the selected pages converted to the well-known html based format. By way of comparison, prior solutions of the WebEx type handle all types of documents by converting the documents to vector based graphics. Using the method in accordance with the present invention, the user can highlight important parts of the document and add personal comments with the help of voice and graphic annotations. The user can then save the resulting composite document along with the annotations as a collaboration document at the IIS (Internet Information Server), for example, and send the collaboration document's URL link to other participants.

The recipient can view the collaboration document URL upon receiving the e-mail from the sender. As the collaboration documents are stored at a centralized server, they are readily amenable to document management tasks, including deleting, moving, etc. The above process allows various users to collaborate over documents quickly and easily by only sharing information relevant to the topic in question. In addition, there is an increase in productivity as users can quickly exchange information without having to exchange several e-mails to explain problem and/or a solution.

This offline collaboration process enables users to collaborate using rich multimedia but in a “lightweight” manner, namely the recipients need only a regular web browser to view the annotated documents. As the audio is streamed synchronously along with the annotations, these annotated documents are viewable on very low bandwidth environments (as low as 28 K). Therefore, users can effectively collaborate irrespective of whether they are in high bandwidth environment or in dial-up environments. The collaboration (i.e. annotated) documents can be stored at a web server and streamed to users (which is easier to manage and more secure) or sent as an attachment (which is good in case the recipient wants to view the document when offline).

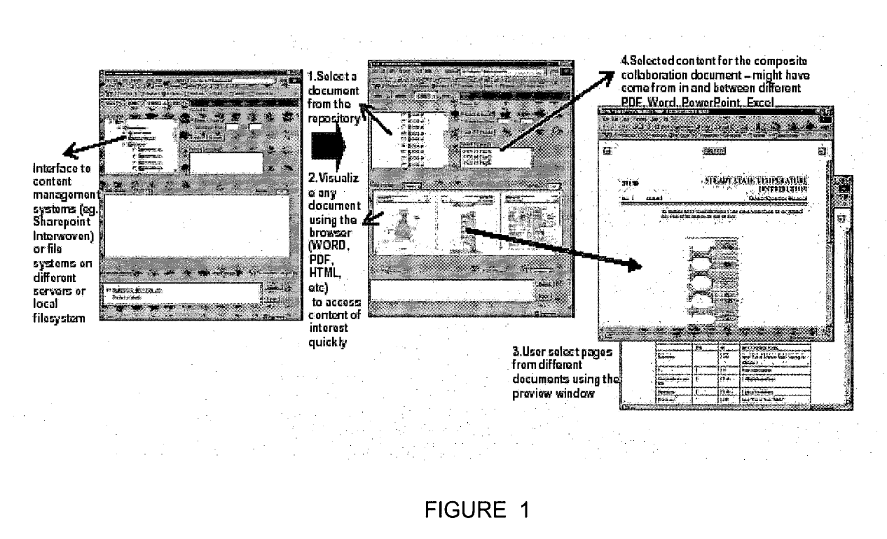

FIGS. 1-3 show steps in an exemplary embodiment of the system in accordance with the present invention. The figures illustrate a particular workflow example that was implemented to demonstrate browser based asynchronous collaboration using office documents and web content. The components can be re-used in several other collaboration workflows and processes.

FIG. 1 shows a particular exemplary workflow embodiment in accordance with the invention, demonstrating browser based asynchronous collaboration using office documents and web content. The components can be re-used in several other collaboration workflows and processes. In FIG. 1, the creation of a composite document by the host of a collaboration event. The interface is sent to content management systems (eg., Sharepoint, Interwoven) or file systems on different servers or local file system. At view 1, a document is selected from the repository. View 2 illustrates the visualizing of any document using the browser (WORD, PDF, HTML, etc) to access content of interest quickly. At view 3, the user selects pages from different documents using the preview window. View 4 shows selected content for the Composite Collaboration Document—this might have come from in and between different PDF, Word, PowerPoint, Excel2.

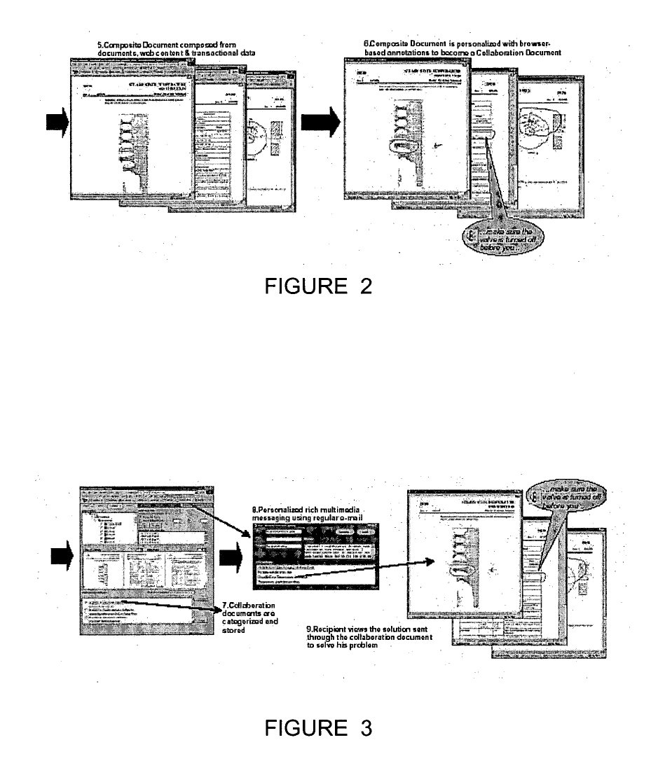

FIG. 2 shows an example of a feature wherein the host can add highlight specific regions and add synchronous voice annotations using easy to use browser based controls. In view 5, a Composite Document composed from documents, web content & transactional data, and in view 6, a Composite Document is personalized with browser based annotations to become a Collaboration Document 5.

FIG. 3 shows an example of a feature wherein the sender sends the URL link to the annotated composite document to recipient using regular e-mail. The recipient can view the collaboration document using just a regular web browser (effective even under low bandwidth environment like dial-up 28 k or 56 k). View 7 shows an example of a feature wherein Collaboration documents are categorized and stored. View 8 shows an example of personalized rich multimedia messaging in accordance with an aspect of the invention, using regular e-mail. View 9 shows, by way of example, a feature wherein a recipient views the solution sent through the collaboration document to solve his problem.

Extensions to video and other forms of continuous media will next be described. It is now commonplace for users in enterprises to utilize video for communicating important information. Typically, video libraries built up over time are available on streaming servers at some central location. A particular video file might be extremely lengthy, and a clip of interest might be just a few minutes long embedded somewhere in this lengthy file. For example, an engineer at a remote plant-site might want to just view streaming video demonstrating the replacement of a valve instead of the entire plant commissioning video file.

The off-line collaboration component in accordance with the present invention provides a web-based scheme to view a large video file and be able to extract small clips of interest for the purpose of collaboration. Each clip can be further personalized by associating the particular clip with relevant web documents to create a ‘hypervideo’ clip. A hypervideo clip is a video clip with hyperlinks to web content overlaid on the video and wherein users viewing the clip can invoke additional information about the clip by clicking on that hyperlink. Users can create several such hypervideo clips from several video files and create a “collaboration” video repository including different categories of video clips. A user can select one or more such clips, combine them with one or more personalized collaboration documents described in previous sections, and create a composite multimedia presentation that contains parts of video files, documents, images, etc., and annotations.

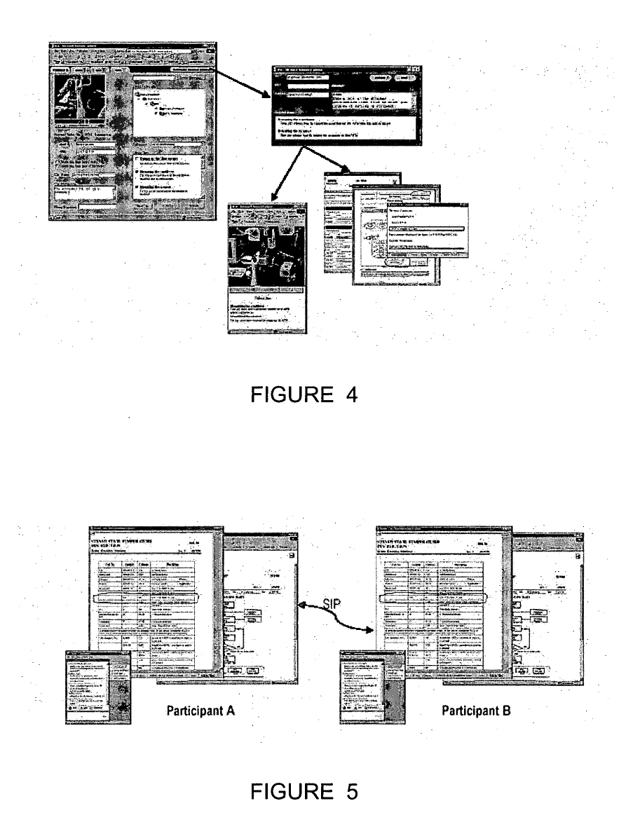

As mentioned in the previous section, a user can utilize the messaging component of the present invention to just e-mail the URL of the presentation to other networked users who can then view the presentation with the guarantee that the multimedia content in the presentation will be streamed after adapting to the network and device characteristics. An embodiment of workflow highlighting the video personalization and collaboration scenario is shown in FIG. 4. Here a user can create and select a “virtual” video clip which represents a part of a video and also send a voice/graphic annotated composite document. The remote recipient receives a BURL which encapsulates all the multimedia information. By clicking the URL, the multimedia presentation containing the virtual video, annotated document, images, etc., is recreated and personalized for the recipient's device and network capabilities.

This model of combining seamlessly specific information located in several documents (video, web, office documents, images, etc) and the ability to annotate and save or send to other recipients is extended to near real-time and real time collaborations.

An aspect of the present invention relating to near real time collaboration using composite documents will next be described. Currently, users have generally been utilizing two ways to collaborate over documents (office documents or web content) either by using e-mail (as described above) or by having to set up real time web conferences. In the case of e-mail, the participation is asynchronous and there is effectively no real time exchange of ideas. On the other hand, real time conferences require significant efforts to set up and manage. They also assume the availability and presence of all participants for the entire session. In accordance with the principles of the present invention, a collaboration solution allows asynchronous interactions within a real time collaboration session.

Instant messaging in text or voice form has proved to be a solution that brings together the benefits of the asynchronous nature of e-mail and the real time exchange of ideas of a web conference. The near real time collaboration solution herein described facilitates ad-hoc collaboration sessions based on presence information and documents. Hence, for instance, if a user has a problem or clarification concerning a technical/business issue, the user can check if any other user is available and can help. The users can then set up a collaboration session immediately and share information with the help of collaboration documents discussed earlier.

The solution allows the participants in the collaborative session to discuss the contents of the collaboration document in detail with the help of voice and graphics annotations. Using annotations on collaboration documents also brings the benefits of the ability to collaborate over low bandwidth environments and across firewall restrictions. Also, the users can avoid the use of application sharing just for sharing information that is spread across a multitude of documents. Moreover, by having the ability to save annotations and IM messages, the information and knowledge gathered during a collaboration session is not lost.

The foregoing sections have described the process used to create a virtual composite document. In the near real time collaboration scenario, the person hosting the collaboration session can compose the document then place it at a web browser where other participants can access it. The advantage of using a composite document is that users need see only the information that is relevant to the session.

In this scenario annotations are sent to other participants only when the user is satisfied with his/her annotation and clicks the “Send” button (similar to the user's behavior when using IM for text messaging). Participants can contribute, and review contributions from other participants at their own pace. The effect of this process is to enable participants to contribute asynchronously within a real time collaboration session. While this solution is not universal, there are many situations when these ad-hoc collaborative sessions may be exactly what the users need. For instance, during the session, a participant can look up certain information while other participants continue with other activities such as, for example, reading e-mail. In another scenario, for example, technical support, a call center agent could suggest that a customer try a particular repair procedure and during that period handle other requests. Thus, in a near real time collaboration, while one participant is reading the marked up document, the other participants can follow up other activities.

Currently, knowledge gained during real time conference sessions by using annotations on documents or web content is lost, as they are not saved. The system in accordance with the present invention allows for saving of annotations both graphics/audio along with the composite document and IM message text for future reference.

Also, multiple participants can work on a composite document and build it further either by adding specific pages from other documents or by adding personal audio and graphic annotations. This allows, for instance, several call center agents to put together a composite document and have annotations on it all saved as collaboration document, which the end-customer could use to solve his problem.

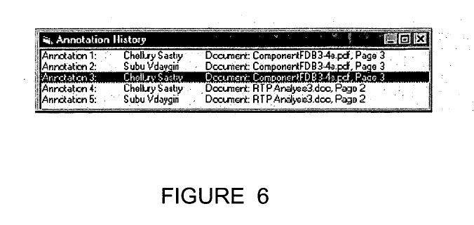

FIG. 5 shows an exemplary collaboration scenario in which Participants A and B are coupled by way of SIP protocol. In near real time collaboration scenario, a user uses IM with browser based annotations to discuss documents. Here participant A has questions regarding a document, finds that participant B is available based on presence and starts impromptu instant messaging conversation. Participant A can choose the specific pages from the document(s) for discussion with B. Participant A creates a synchronous voice and graphic annotation on a particular page. By clicking “Send” in the annotation bar at the bottom of the browser, the voice and graphic annotation is sent to participant B. Participant B gets a notification that an annotation has arrived and can play it. The browser at user B shows the appropriate page of the document and plays the annotation. Participant B can respond with another annotation or reply by text using IM client. By clicking “History” in the annotation bar, the user can view list of all annotations during the session and can play any or all of them. Finally, either user can save the composite document along with some or all voice/graphic annotations for future reference. An example is shown in FIG. 6 of history of annotations during a collaboration session which participants can view as well as review any particular voice/graphic annotation.

This section describes the real time collaboration capabilities in accordance with the principles of the present invention, including real time collaboration using documents and web content. In this context, the system in accordance with the present invention utilizes existing components and solutions, such as voice conference call capabilities. For example, the system can utilize MCU (Multipoint Control Unit) and SIP (Session Initiation Protocol) based collaboration components. The Microsoft instant messaging tool is an example of a system that already provides for application and whiteboard sharing on Windows XP. Integrating these MCU based voice conference, MS application & whiteboard sharing along with SCR's browser based document collaboration components allows the development of a comprehensive real time collaboration solution that is also a seamless extension to the offline and near real time collaboration functionality described in previous sections. The difference from the near real time collaboration scenario is the ability for multiple participants to collaborate over documents or web content while participating in a voice conference. By integrating a user's document processing services with Exchange (and SharePoint), the users can combine specific information retrieved from different document and web content repositories. The information extracted from several documents of different types (Word, Excel, PDF, PowerPoint, Graphics, etc.,—basically any printable document) is combined into a web based composite document that is adaptable to different network bandwidths and device capabilities (by way of comparison, WebEx generates vector based graphics of the original document(s).

The use of SVG (Scaleable Vector Graphics) can also be considered. Utilizing a user's composite document creation components, the host can optionally share only those parts of the document(s) relevant to a particular collaboration session and hence maintain confidentiality and security. A composite document (in the most simple case—it could be just one document) created for a particular collaborative session is pushed to all participants. Participants in a real time conference can do various voice and graphic annotations while having a phone conference. While a participant is making an annotation, the annotation is sent in real time to all (or to specific) participants. Several participants can annotate on the document and the graphic annotations are overlaid. Unlike the asynchronous and near real time scenarios, the voice annotations are not transferred between participants as all the participants are already in a voice/video conference. But the voice and graphic annotations for the session are recorded and stored along with the composite document (the annotation data can be stored separately).

The real time collaboration solution allows for multi-node multiple-participant collaboration on a particular document(s). For instance, a group of users could work on a composite document to solve a particular problem a customer is facing. Logging of various activities in collaboration sessions would help in analyzing the productivity and efficiency of various collaboration processes. Some of the detailed logging of collaboration sessions would involve:
How much time was spent in gathering information from different sources into a composite document?
How much time did each participant spend annotating the document?
How much time was spent in offline, near on-line and in real time conversations?
How much information from previous collaboration sessions was used in addressing new customer questions?

In summary, advantages of the collaboration solution in accordance with the present invention include:
Address all collaboration modes (offline, near real time and real time) in an integrated manner.
Easy to use web browser based collaboration solution
Composite web based document allows combining information from disparate sources
Especially effective solution for low bandwidth connections and environments with firewalls
Annotation—both graphic & voice—can be saved separately from documents
Knowledge build up—reuse of knowledge gained during collaboration sessions
Seamless conversion of a collaboration session from offline to near on-line to real time
Collaboration solution for office documents, web content and rich multimedia
Collaboration logging and reporting tools
Light weight SIP based solution for near real time and real time collaboration
Components can be re-used for different workflows and scenarios
Cost effective collaboration tools for customers
Move from ad-hoc interactions to a streamlined collaborative enterprise environment

Siemens Corporate Research, Inc., Princeton, N.J. (SCR) has developed a number software components that utilize documents and web & multimedia content to enhance collaboration processes in an enterprise. These components are well suited for integration for facilitating seamless collaboration within various business processes in accordance with a preferred embodiment of the present invention. Utilizing these components, the above-described comprehensive solutions for offline, near real time and real time collaborations can be advantageously implemented and developed. The components include browser based collaboration tools, resulting in a collaborative environment working seamlessly with e-mail or instant messaging. This leads to a more effective mode for sharing of information and knowledge leading to higher productivity.

The invention has been described by way of exemplary embodiments and is best practiced with the application of one or more programmable digital computers. As will be understood by one of skill in the art to which the present invention pertains, various changes and modifications will be apparent. Such changes and substitutions which do not depart from the spirit of the invention are contemplated to be within the scope of the invention which is defined by the claims following.

1. A method for multimedia collaboration between a plurality of users including a host of a collaboration event, comprising the steps of:
storing an interface representative of said plurality of users in a memory location commonly accessible to said users;
creating a composite document from selected source materials;
selectively annotating said composite document; and
personalizing said composite document with browser based annotations to form a collaboration document.

2. A method for multimedia collaboration as recited in claim 1, wherein said step of selectively annotating comprises a step selectively highlighting specific regions and adding synchronous voice annotations.

3. A method for multimedia collaboration as recited in claim 2, wherein said step of selectively annotating comprises a step of adding any of dynamic and static annotations.

4. A method for multimedia collaboration as recited in claim 1, wherein said step of selectively annotating comprises a step of selectively adding highlights to specific regions and adding synchronous voice annotations.

5. A method for multimedia collaboration as recited in claim 4, wherein said step of selectively annotating comprises a step of adding any of dynamic and static annotations.

6. A method for multimedia collaboration as recited in claim 1, wherein said step of selectively annotating comprises a step of selectively adding a video file.

7. A method for multimedia collaboration as recited in claim 1, wherein said step of selectively annotating comprises a step of selectively adding a video clip.

8. A method for multimedia collaboration as recited in claim 7, wherein said step of adding a video clip comprises a step of selecting said video clip from a stored video file.

9. A method for multimedia collaboration as recited in claim 8, wherein said step of adding a video clip comprises a step of adding hyperlinks to said video clip.

10. A method for multimedia collaboration as recited in claim 1, wherein said step of selectively annotating comprises using browser based controls.

11. A method for multimedia collaboration as recited in claim 1, including the steps of:
storing said collaboration document in said memory location commonly accessible to said users; and
sharing retrieval address information for said collaboration document with said users.

12. A method for multimedia collaboration as recited in claim 1, wherein said step of storing an interface comprises sending said interface to any of:
(a) a content management system of the type represented by Sharepoint, Interwoven, and the like,
(b) file systems on different servers, and
(c) a local file system.

13. A method for multimedia collaboration as recited in claim 11, wherein said step of sharing retrieval address information comprises sending retrieval address information by e-mail.

14. A method for multimedia collaboration as recited in claim 11, including a step of categorizing and storing said collaboration document.

15. A method for multimedia collaboration as recited in claim 1, wherein said step of personalizing said composite document comprises using e-mail.

16. A method for multimedia collaboration as recited in claim 15, wherein said step of personalizing comprises utilizing rich multimedia messaging by way of e-mail.

17. A method for multimedia collaboration between a plurality of users of a collaboration event, comprising the steps of:
storing an interface representative of said plurality of users in a memory location commonly accessible to said users;
creating a composite document from selected source materials;
selectively annotating said composite document;
personalizing said composite document with browser based annotations to form a collaboration document;
storing said collaboration document in said memory location commonly accessible to said users;
establishing instant conferencing amongst said plurality of users;
selectively making and locally storing further annotations to said collaboration document;
selectively sending at a desired time said further annotations to said collaboration document in said memory location commonly accessible to said users; and
wherein the foregoing steps are also selectively performed in an ongoing manner during said instant conferencing.

18. A method for multimedia collaboration as recited in claim 17, wherein said step of selectively annotating is repeatedly performed by any of said users and results thereof are overlaid and stored.

19. A method for multimedia collaboration as recited in claim 17, wherein said step of selectively annotating includes selectively annotating with any of animation, graphics, voice, and video.

20. A method for multimedia collaboration as recited in claim 17, wherein said step of establishing instant conferencing includes establishing voice conferencing.

21. A method for multimedia collaboration as recited in claim 17, wherein said step of establishing instant conferencing includes establishing video conferencing.

22. A method for multimedia collaboration as recited in claim 17, wherein said step of creating a composite document comprises creating said composite document in conformance with needs of said users and applicable confidentiality and security requirements.

23. A method for multimedia collaboration between a plurality of users including a host of a collaboration event, comprising the steps of:
storing an interface representative of said plurality of users in a memory location commonly accessible to said users;
creating a composite document from selected source materials;
selectively annotating said composite document;
personalizing said composite document with browser based annotations to form a collaboration document;
storing said collaboration document in said memory location commonly accessible to said users;
sharing retrieval address information for said collaboration document with said users;
making and locally storing further annotations to said collaboration document; and
selectively sending at a desired time said further annotations to said collaboration document in said memory location commonly accessible to said users.

24. A method for multimedia collaboration as recited in claim 23, wherein said step of selectively annotating comprises a step wherein said selectively adds highlight specific regions and adds synchronous voice annotations.

25. A method for multimedia collaboration as recited in claim 23, wherein said step of selectively annotating comprises using browser based controls.

26. A method for multimedia collaboration between a first user and at least a second user, comprising the steps of:
said first user selecting a document page for said collaboration;
said first user optionally associating user-entered data with said document page;
said first user saving said document page together with said user-entered data associated therewith as a collaboration document in a memory location commonly accessible to said first and said second user;
said first and second users establishing message communication for said collaboration;
said second user retrieving said collaboration document, including said user-entered data associated therewith; and
said first and second users optionally modifying said user-entered data in the context of said collaboration.

27. A method for multimedia collaboration as recited in claim 26, wherein said step of said first user selecting a document comprises selecting a document from any of a server, a data repository, a shared portal, disk storage, a database, and the Web.

28. A method for multimedia collaboration as recited in claim 26, wherein said step of said first user optionally associating user-entered data with said document page comprises a step of associating any of voice and graphic annotations.

29. A method for multimedia collaboration as recited in claim 26, wherein said step of said first user optionally associating user-entered data with said document page comprises a step of associating audio and graphic annotations and a step of streaming said audio synchronously along with said graphic annotations.

30. A method for multimedia collaboration as recited in claim 26, wherein said step of saving said document page comprises saving said document page in a format requiring only a regular web browser to view said annotated documents.

31. A method for multimedia collaboration as recited in claim 26, wherein said step of saving said document page comprises saving said document page with a URL (Universal Resource Locator) in an Internet information server and wherein said step of establishing message communication comprises said first user communicating said URL to said second user.

32. A method for multimedia collaboration as recited in claim 26, wherein said step of creating a composite document comprises creating said composite document in conformance with needs of said users and applicable confidentiality and security requirements

33. A system for multimedia collaboration between a plurality of users including a host of a collaboration event, comprising:
means for storing an interface representative of said plurality of users in a memory location commonly accessible to said users;
means for creating a composite document from selected source materials;
means for selectively annotating said composite document; and
means for personalizing said composite document with browser based annotations to form a collaboration document.

34. A system for multimedia collaboration between a plurality of users of a collaboration event, comprising:
means for storing an interface representative of said plurality of users in a memory location commonly accessible to said users;
means for creating a composite document from selected source materials;
means for selectively annotating said composite document;
means for personalizing said composite document with browser based annotations to form a collaboration document;
storing said collaboration document in said memory location commonly accessible to said users;
establishing instant conferencing amongst said plurality of users;
selectively making and locally storing further annotations to said collaboration document;
selectively sending at a desired time said further annotations to said collaboration document in said memory location commonly accessible to said users; and
wherein the foregoing steps are also selectively performed in an ongoing manner during said instant conferencing.

35. A system for multimedia collaboration between a plurality of users including a host of a collaboration event, comprising:
means for storing an interface representative of said plurality of users in a memory location commonly accessible to said users;
means for creating a composite document from selected source materials;
means for selectively annotating said composite document;
means for personalizing said composite document with browser based annotations to form a collaboration document;
means for storing said collaboration document in said memory location commonly accessible to said users;
means for sending retrieval address information for said collaboration document to said users;
means for making and locally storing further annotations to said collaboration document; and
means for selectively sending at a desired time said further annotations to said collaboration document in said memory location commonly accessible to said users.

36. A method for multimedia collaboration between a plurality of users for a collaboration event, comprising the steps of:
storing an interface representative of said plurality of users in a memory location commonly accessible to said users;
creating a composite document from selected source materials;
selectively annotating said composite document;
personalizing said composite document with browser based annotations to form a collaboration document;
storing said collaboration document in said memory location commonly accessible to said users;
sharing retrieval address information for said collaboration document with said users; and
selecting a collaboration mode for said collaboration event respecting said collaboration document, wherein said collaboration mode comprises any of said offline, near real time, real time, and disconnected modes.

37. A method for multimedia collaboration as recited in claim 36, including a step of generating and storing a log of said collaboration.

38. A method for multimedia collaboration as recited in claim 36, wherein said step of selecting a collaboration mode comprises selecting a single one of said offline, near real time, real time, and disconnected modes.

39. A method for multimedia collaboration as recited in claim 36, wherein said step of selecting a collaboration mode comprises selecting a plurality of said offline, near real time, real time, and disconnected modes.

40. A method for multimedia collaboration as recited in claim 39, including a step of generating and storing a log of said collaboration.

41. A method for multimedia collaboration as recited in claim 36, wherein said step of selecting a collaboration mode comprises selecting a plurality of said offline, near real time, real time, and disconnected modes and causing a selective seamless transition from one selected mode to another.

42. A method for multimedia collaboration as recited in claim 41, including a step of generating and storing a log of said collaboration.
